(19) United States
(12) Patent Application Publication
(10) Pub. No.: US 2008/0152970 A1
(43) Pub. Date: Jun. 26, 2008

(54) Minimizing coke formation in a reformer

(76) Inventors: Kenneth M. Rush, Clifton Park, NY (US); Rebecca A. Dinan, Rochester, NY (US)

Correspondence Address: TROP PRUNER & HU, PC, 1616 S. VOSS ROAD, SUITE 750, HOUSTON, TX, 77057-2631, US

(21) Appl. No.: 11/645,217

(22) Filed: Dec. 22, 2006

(51) Int. Cl. H01M 8/04

(52) U.S. Cl. 429/17; 429/22

(57) ABSTRACT

A technique includes controlling the formation of coke during a startup phase of a reformer. The controlling includes during the startup phase regulating a hydrocarbon flow rate into the reformer to be near or below a lower boundary of a range of rates over which the hydrocarbon flow rate varies after the startup phase.

### BACKGROUND

The invention generally relates to minimizing coke formation in a reformer, such as a reformer of a fuel cell system, for example.

A fuel cell is an electrochemical device that converts chemical energy directly into electrical energy. There are many different types of fuel cells, such as solid oxide, molten carbonate, phosphoric acid, methanol and proton exchange member (PEM) fuel cells.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C.) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The hydrogen for a PEM fuel cell may be furnished, for example, by a hydrogen storage tank or alternatively, by a reformer, which generates the hydrogen from a hydrocarbon flow (such as a natural gas or liquefied petroleum gas (LPG) flow, as examples). A significant amount of coke may form in the reformer during its startup phase, which may significantly restrict flow passageways of the reformer.

Thus, there exists a continuing need for better ways to start up a reformer for purposes of limiting the formation of coke.

### SUMMARY

In an embodiment of the invention, a technique includes controlling the formation of coke during a startup phase of a reformer. The controlling includes during the startup phase regulating a hydrocarbon flow rate into the reformer to be near or below a lower boundary of a range of rates over which the hydrocarbon flow rate varies after the startup phase.

In another embodiment of the invention, a fuel cell system includes a reformer, a fuel cell and a controller. The reformer provides and the fuel cell receives a reformate flow. The controller controls formation of coke during a startup phase of the reformer. The controller is adapted to during the startup phase, regulate a hydrocarbon flow rate into the reformer to be near or below a lower boundary of a range of rates over which the hydrocarbon flow rates varies after the start phase.

In yet another embodiment of the invention, an article includes a computer readable storage medium that is accessible by a processor-based system to store instructions that when executed by the processor-based system cause the processor-based system to during a startup phase a reformer, regulate a hydrocarbon flow rate into the reformer to be near or below a lower boundary of a range of rates over which the hydrocarbon flow rate varies after the startup phase to prevent formation of coke.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a schematic diagram of a reformer of the fuel cell system of FIG. 1 according to an embodiment of the invention.

FIG. 3 is a graph illustrating a relationship between an oxygen-to-carbon ratio and a temperature of the reformer.

FIG. 4 is a coking diagram.

FIG. 5 is a graph illustrating a relationship of hydrogen production as a function of an oxygen-to-carbon ratio.

FIG. 6 is a flow diagram illustrating a technique to minimize coke formation in a reformer according to an embodiment of the invention.

### DETAILED DESCRIPTION

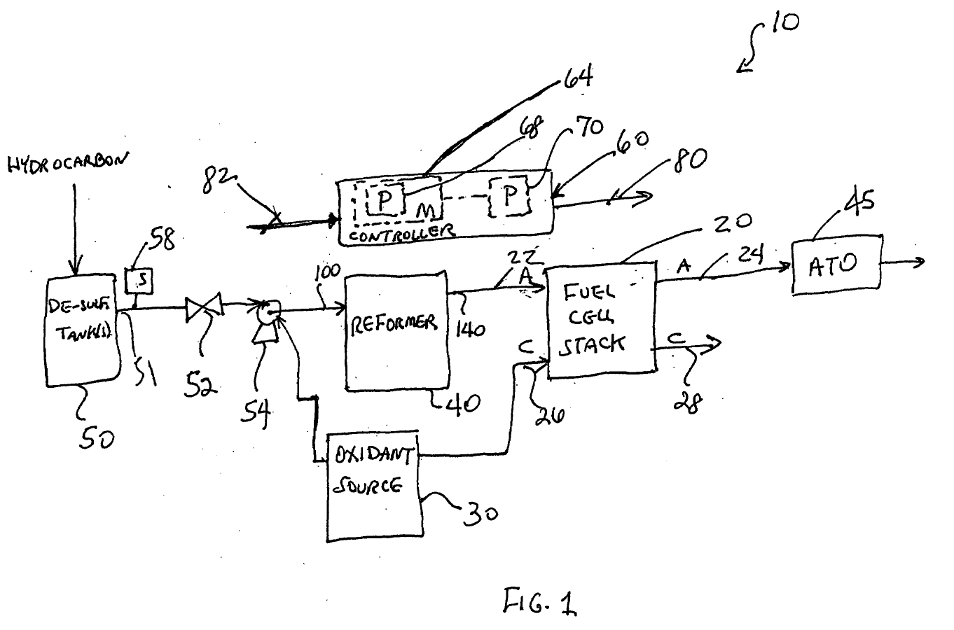

Referring to FIG. 1, in accordance with embodiments of the invention described herein, a fuel cell stack 20 of a fuel cell system 10 receives fuel and oxidant flows for purposes of producing electrical output power for an external load (not shown in FIG. 1) of the system 10. More particularly, the fuel cell stack 20 includes an anode inlet 22 that receives a reformate flow from a reformer 40 of the fuel cell system 10. The fuel flow flows through the anode chamber of the fuel cell stack 20 to promote electrochemical reactions inside the stack 20, and the fuel flow produces an anode exhaust flow, which appears at an anode outlet 24 of the stack 20. An anode tailgas oxidizer (ATO) 45, which may be part of the reformer 40, combusts remaining fuel in the anode exhaust during normal operation of the fuel cell system 10. The oxidant flow to the fuel cell stack 20 is provided by an oxidant source 30 of the fuel cell system 20 and is received at a cathode inlet 26 of the fuel cell stack 20. The oxidant flow promotes electrochemical reactions inside the fuel cell stack 20 and produces a corresponding cathode exhaust, which appears at a cathode outlet 28 of the stack 20.

It is noted that the oxidant source 30 may have many different designs, depending on the particular embodiment of the invention. In this regard, the oxidant source 30, in accordance with some embodiments of the invention, may be formed from a cathode air blower and a three-way valve, as further described in U.S. patent application Ser. No. ______, entitled, “CONTROLLING OXIDANT FLOWS IN A FUEL CELL SYSTEM,” which has a common assignee with this application, is filed concurrently herewith and is hereby incorporated by reference in its entirety.

The reformer 40 receives a hydrocarbon flow (a flow containing natural gas or liquefied petroleum gas (LPG) flow, as examples) at an inlet 100 and reforms the hydrocarbon flow to produce the corresponding reformate flow, a flow that contains diatomic hydrogen, which serves as fuel for the electrochemical reactions in the fuel cell stack 20. To promote the reactions inside the reformer 40, the reformer 40 also receives an air flow that may originate from the oxidant source 30. In some embodiments of the invention, the air and fuel flows to the reformer 40 may be combined at a blower 54 that furnishes the hydrocarbon flow to the inlet 100 of the reformer 40.

During the initial startup of the fuel cell system 10, the reformer 40 also starts up (i.e., transitions through a startup phase in which the temperature and internal steam production rise to the appropriate levels); and during this startup phase, a significant amount of coke may form in the passageways of the reformer 40, if not for the techniques that are described herein. The formation of coke is undesirable, as coke may impede passageways of the reformer 40 and fuel cell system 10. For purposes of reducing coke formation during the startup of the reformer, a controller 60 of the fuel cell system 10 limits the incoming hydrocarbon flow rate to the reformer 40, a technique that has been discovered, as described herein, to limit the formation of coke. As an example, the incoming hydrocarbon flow rate to the reformer 40 for the startup phase of the reformer 40 may be near or below the lowest boundary of the range of rates over which the hydrocarbon flow rate is controlled during normal operation of the reformer 40, i.e., during the non-startup phase of the reformer 40.

As a more specific example, in accordance with some embodiments of the invention, the fuel cell system 10 may control the incoming hydrocarbon flow rate to the reformer 40 to be in the general range of 3 to 15 standard liters per minute (slm) during normal, non-startup, operation of the reformer 40, depending on the fuel cell system's operating conditions. Continuing this example, during the startup of the reformer 40, the fuel cell system 10 limits the incoming hydrocarbon low rate to the reformer 40 to be near or below 3 slm, the lowest rate of the range. It is noted these specific numbers are given for purposes of illustrating a particular embodiment of the invention. Other flow rates and ranges are contemplated and may be used in accordance with the many possible embodiments of the invention, as all of these variations fall with the scope of the appended claims.

As depicted in FIG. 1, in accordance with some embodiments of the invention, a hydrocarbon flow, such as a natural or LPG gas flow (as examples), is received into the fuel cell system 10 at one or more desulfurization tanks 50. The tank(s) 50 removes mercaptens and other sulfur compounds from the hydrocarbon flow to produce a relatively pure hydrocarbon flow (i.e., a flow that is relatively free of sulfur compounds) that exits an outlet 51 of the tank(s) 50. The flow is communicated through a variable flow path flow control valve 52, which controls the incoming hydrocarbon flow rate to the reformer 40 and is regulated by the controller 60. The outlet of the valve 52 may be connected to a suction inlet of the blower 54.

In accordance with some embodiments of the invention, the controller 60 controls the incoming hydrocarbon flow rate to the reformer 40 by controlling the cross-sectional flow area of the valve 52. As a more specific example, in accordance with some embodiments of the invention, the valve 52 may be a solenoid valve, although other valves and flow control mechanisms may be used, in accordance with other embodiments of the invention.

For purposes of regulating the hydrocarbon flow to a desired rate, the controller 60 may monitor the hydrocarbon flow via a flow meter 58, which may be coupled to the outlet 51 of the tank(s) 50, in accordance with some embodiments of the invention.

The controller 60 may include one or more processors 70 in accordance with some embodiments of the invention. The processor 70 may represent one or more microprocessors or microcontrollers, depending on the particular embodiment of the invention. Additionally, the processor 70 may be coupled to a memory 64, which may be internal or external to the controller 60, depending on the particular embodiment of the invention. The memory 64 stores program instructions 68 that when are executed by the processor 70, cause the controller 60 to perform one or more of the techniques that are disclosed herein. More specifically, the instructions 68 when executed by the processor 70 cause the controller 60 to perform techniques related to the control of coke formation, as well as other startup phase and non-startup phase operations of the fuel cell system 10.

As depicted in FIG. 1, the controller 60 may be in communication with various output communication lines 80 for purposes of controlling various components of the fuel cell system 10. As a non-exhaustive exemplary list, these elements may include various motors, valves, blowers, electrical conditioning circuitry, etc. The controller 60 may also be in communication with various input electrical communication lines 82, for purposes of receiving communications from other controllers, information from sensors, communications of cell voltages, and communications of various system currents and voltages, as just a few examples. As a more specific example, in accordance with some embodiments of the invention, the controller 60 is in communication with the flow meter 58, one or more sensors of the reformer 40 (to determine such parameters as the oxygen-to-carbon ratio, steam mixing temperature, ATR temperature, etc., of the reformer 40); and based on feedback and predictions made by the controller 60, the controller 60 regulates operations of the solenoid valve 52, fuel blower 54 and oxidant source 30, among other components of the fuel cell system 10. Other variations are possible and are within the scope of appended claims.

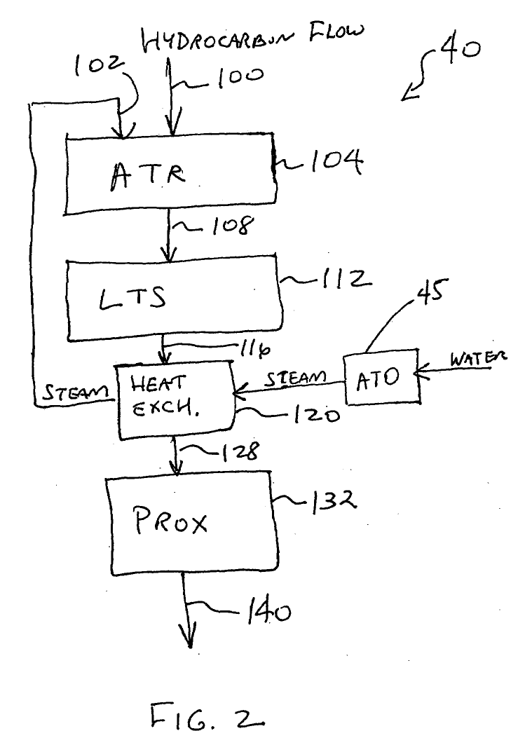

Referring to FIG. 2, in accordance with some embodiments of the invention, the reformer 40 includes an autothermal reactor (ATR) 104, which receives the incoming hydrocarbon flow. The ATR 104 produces a hydrogen flow, which exits the ATR 104 and is received at an inlet 108 of the low temperature shift (LTS) reactor 112 of the reformer 40. An exhaust from the LTS 112 is communicated to an inlet 116 of a heat exchanger 120.

The heat exchanger 120 receives steam that is generated by the ATO 45 and heat transferred from the exhaust of the LTS 112 for purposes of generating steam, which is used in the reforming operation by the ATR 104. It is noted that the ATR 104 may receive steam from other components of the fuel cell system 10, depending on the particular embodiment of the invention.

As depicted in FIG. 2, in accordance with some embodiments of the invention, the exhaust from the heat exchanger 116 is communicated to an inlet 128 of a preferential oxidation (PROX) reactor 132. The PROX reactor 132 furnishes the final reformate flow to an outlet 140 of the reformer 40.

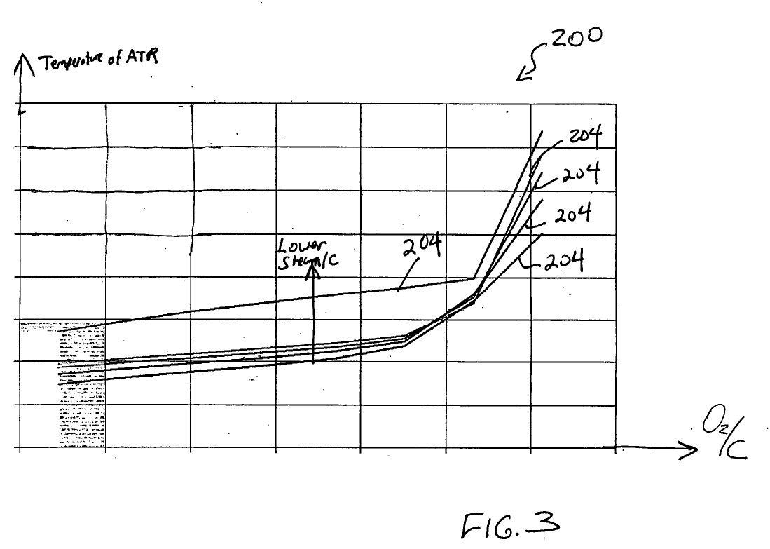

The reformer's oxygen-to-carbon ratio typically has been regulated and thus, kept to a low value during reformer startup to prevent the ATR temperature from exceeding an upper temperature threshold. More specifically, as depicted in FIG. 3, a graph 200 of the ATR temperature versus the oxygen-to-carbon ratio reflects a general increase in the ATR temperature with the oxygen-to-carbon ratio. FIG. 3 depicts different curves 204, illustrating this relationship, where each curve 204 is associated with a different steam-to-carbon ratio. As can be seen, a lower steam-to-carbon ratio generally produces a lower ATR temperature for a given oxygen-to-carbon ratio.

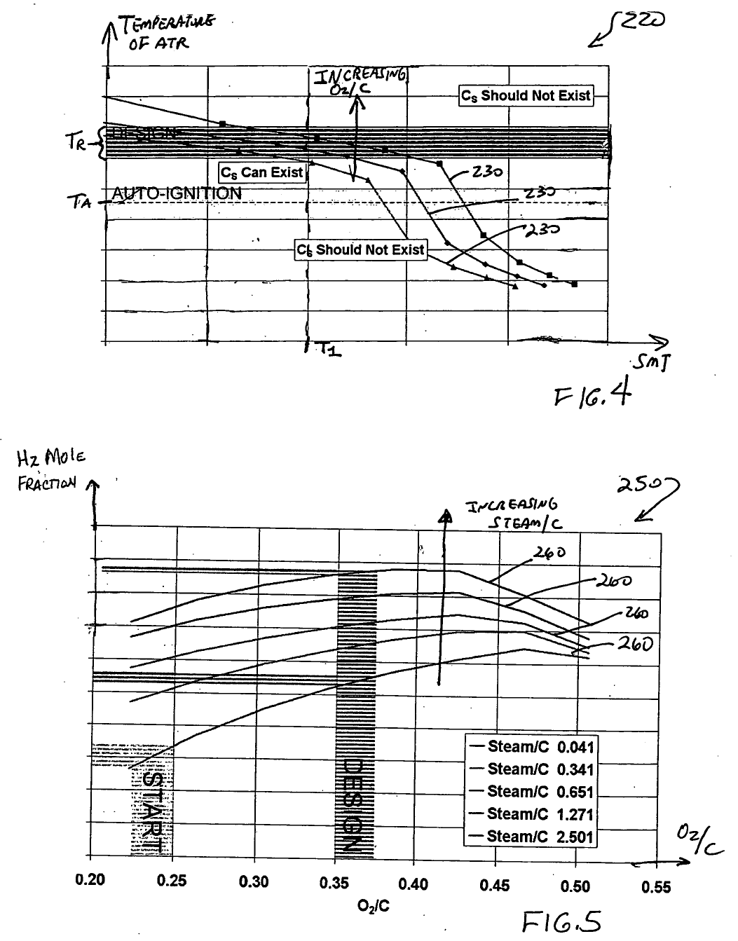

Referring to FIG. 4, it has been discovered that the oxygen-to-carbon ratio is not the primary relationship, which is determinative of whether coking occurs. More particularly, as described herein, it has been discovered that the steam-to-carbon ratio is primarily determinative of whether significant coking occurs. A sufficient steam mixing temperature (directly indicative of the steam-to-carbon ratio) prevents coking. In this regard, as shown in FIG. 4, above a particular steam mixing temperature (called “T₁” in FIG. 4) coking no longer exists, although below the T₁ temperature, coking exists, regardless of the oxygen-to-carbon ratio and ATR temperature. FIG. 4 depicts various curves 230, each of which is associated with a particular oxygen-to-carbon ratio. As shown, as the oxygen-to-carbon ratio increases, the ATR temperature increases.

As a result of the recognition that coking does not occur with a steam mixing temperature (or steam-to-carbon ratio) above the T₁ temperature, during the startup phase of the reformer 40, the coking is minimized by minimizing the time in which the steam mixing temperature is below the T₁ temperature. In order for this to occur, the steam production in the reformer 40 is maximized during the reformer's startup phase.

For purposes of increasing the internal steam production during the startup phase, the molar flow of hydrogen to the LTS 112 is maximized. More specifically, FIG. 5 depicts a graph 250, which illustrates a relationship between the hydrogen mole fraction provided by the ATR 104 and the oxygen-to-carbon ratio. In particular, FIG. 5 depicts various curves 260 illustrating a relationship for a given steam-to-carbon ratio. For a higher steam-to-carbon ratio, the hydrogen mole fraction to the LTS is increased. This is in stark contrast to the above-mentioned technique of controlling coke formation by limiting the oxygen-to-carbon ratio, as limiting the oxygen-to-carbon ratio does not achieve the higher hydrogen mole fraction and increased production.

Instead of limiting the oxygen-to-carbon ratio during the reformer's startup to keep the ATR temperature within bounds, the incoming hydrocarbon flow is instead limited, a technique that allows the reformer's overall heat loss (and not the oxygen-to-carbon ratio) to regulate the ATR temperature. As a result of using the reformer's heat loss instead of the oxygen-to-carbon ratio to regulate the ATR's temperature, the oxygen-to-carbon ratio may be maximized. More specifically, it has been discovered that for a low fuel flow to the reformer 40, the overall heat loss from the reformer 40 is significantly greater than the heat transfer due to the heat exchanger 120. As a result, the overall heat loss of the reformer 40 is used to regulate the ATR temperature during the startup phase, thereby allowing the oxygen-to-carbon ratio to be increased to increase steam production to therefore, minimize coke formation.

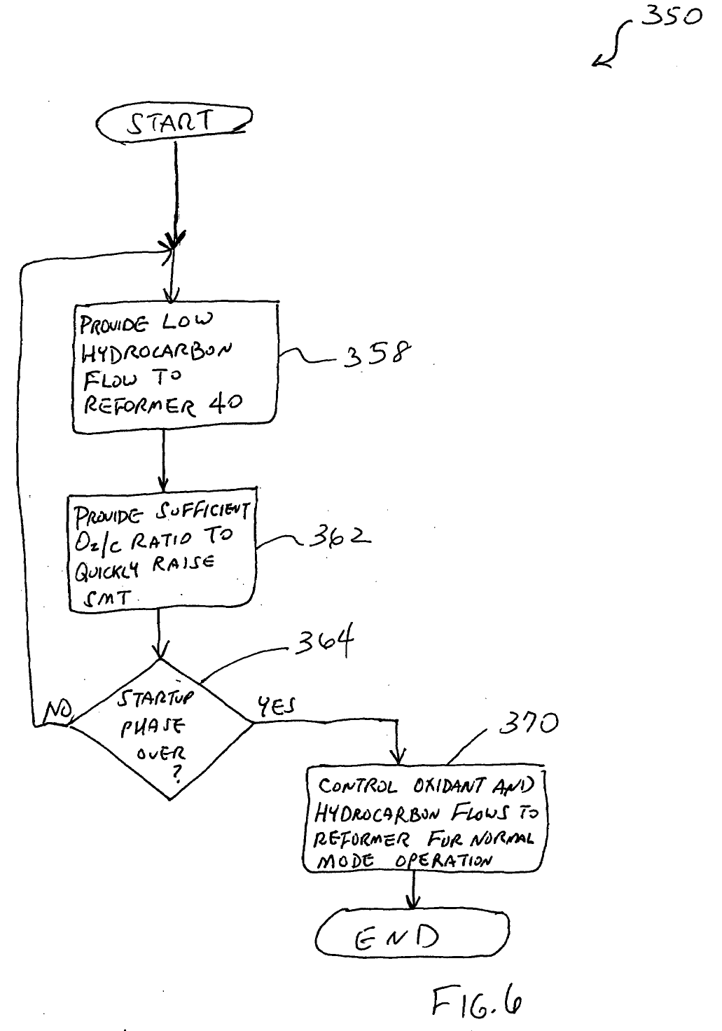

Referring to FIG. 6, to summarize, in accordance with some embodiments of the invention, the controller 60 may use a technique 350 for purposes of controlling the oxidant and hydrocarbon flows to the reformer 40. The technique 350 is executed upon startup of the fuel cell system 10 and thus, at the beginning of the startup phase of the reformer 40.

Pursuant to the technique 350, the controller 60 provides a low hydrocarbon flow (a flow of 3 slm, as an example) to the reformer 40, pursuant to block 358. The controller 60 also provides (block 362) a sufficient oxygen-to-carbon ratio to the reformer 40 to quickly raise the steam mixing temperature. The low hydrocarbon flow and sufficient oxygen-to-carbon ratio are provided until the controller 60 determines (diamond 364) that the reformer's startup phase is complete. After the startup phase, the controller 60 controls the oxidant and hydrocarbon flows to the reformer 40 for its normal mode of operation, pursuant to block 370 (controls the hydrocarbon flow in the range of 3 to 15 slm, as an example). It is noted that the technique 350 is provided merely for purposes of examples, as many other variations (such as different fuel flow rates, for example) are contemplated and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
controlling formation of coke during a startup phase of a reformer, the controlling comprising during the startup phase regulating a hydrocarbon flow rate into the reformer to be near or below a lower boundary of a range of rates over which the hydrocarbon flow rate varies after the startup phase.

2. The method of claim 1, wherein the controlling further comprises controlling an oxygen-to-carbon ratio during the startup phase to decrease a time in which a steam mixing temperature is in a range in which significant coking occurs.

3. The method of claim 2, wherein the act of controlling the oxygen-to-carbon ratio comprises controlling a speed of an air blower.

4. The method of claim 2, wherein the act of controlling the oxygen-to-carbon ratio comprises controlling hydrogen production in the reformer to increase a steam mixing temperature during the startup phase.

5. The method of claim 1, further comprising:
using a heat exchanger of the reformer to generate steam and using the steam to reform a hydrocarbon flow,
wherein the act of regulating the hydrocarbon flow rate into the reformer comprises regulating the hydrocarbon flow to cause an overall heat loss of the reformer to be substantially greater than a heat transfer used to generate the steam.

6. The method of claim 5, further comprising:
using the overall heat loss of the reformer to control a temperature of the reformer during the startup phase

7. The method of claim 1, wherein the act of regulating the hydrocarbon flow rate comprises regulating the flow rate to be near or less than 3 standard liter per minute.

8. The method of claim 1, wherein the act of regulating the hydrocarbon flow rate comprises controlling a valve to control communication of a hydrocarbon to the reformer.

9. A fuel cell system, comprising:
a reformer to provide a reformate flow;
a fuel cell to receive the reformate flow; and
a controller to control formation of coke during a startup phase of the reformer, the controller adapted to during a startup phase of the reformer, regulate a hydrocarbon flow rate into the reformer to be near or below a lower boundary of a range of rates over which the hydrocarbon flow rate varies after the startup phase.

10. The fuel cell system of claim 9, wherein the controller is adapted to control an oxygen-to-carbon ratio during the startup phase to decrease a time in which a steam mixing temperature is in a range in which significant coking occurs.

11. The fuel cell system of claim 10, further comprising:
an air blower, wherein the controller is adapted to control a speed of the air blower to control the oxygen-to-carbon ratio.

12. The fuel cell system of claim 9, wherein controller is adapted to control hydrogen production in the reformer to increase a steam mixing temperature during the startup phase.

13. The fuel cell system of claim 9, wherein the reformer comprises a heat exchanger to generate steam to reform a hydrocarbon flow, and the controller regulates the hydrocarbon flow rate sufficiently low to keep an overall heat loss of the reformer substantially greater than a heat transfer used to generate the steam.

14. The fuel cell system of claim 13, further comprising:
wherein the overall heat loss of the reformer controls a temperature of the reformer during the startup phase.

15. The fuel cell system of claim 9, wherein the controller regulates the flow rate to be near or less than 3 standard liter per minute.

16. The fuel cell system of claim 9, further comprising:
a valve, wherein
the controller controls the valve to control communication of a hydrocarbon to the reformer.

17. An article comprising a computer readable storage medium accessible by a processor-based system to store instructions that when executed by the processor-based system cause the processor-based system to:
during a startup phase of a reformer, regulate a hydrocarbon flow rate into the reformer to be near or below a lower boundary of a range of rates over which the hydrocarbon flow rate varies after the startup phase to prevent formation of coke.

18. The article of claim 17, the storage medium storing instructions that when executed cause the processor-based system to control an oxygen-to-carbon ratio during the startup phase to decrease a time in which a steam mixing temperature is in a range in which significant coking occurs.

19. The article of claim 17, the storage medium storing instructions that when executed cause the processor-based system to regulate the hydrocarbon flow rate to be near or less than 3 standard liter per minute.

20. The article of claim 17, the storage medium storing instructions that when executed cause the processor-based system to control communication of a hydrocarbon to the reformer.
